(19) United States
(12) Patent Application Publication
(10) Pub. No.: US 2006/0112086 A1
(43) Pub. Date: May 25, 2006

(54) Professional matching service

(76) Inventors: Joseph Douress, Easton, PA (US); Peter Previte, Hackettstown, NJ (US); Jay Butchko, Toms River, NJ (US); Bernard P. Kennedy, Chatham, NJ (US); Christopher D. Stagg, Milford, NJ (US); Frank J. Grippo, Parsippany, NJ (US); Eric M. Lee, Berkeley Heights, NJ (US)

Correspondence Address: JACOBSON HOLMAN PLLC, 400 SEVENTH STREET N.W., SUITE 600, WASHINGTON, DC, 20004, US

(21) Appl. No.: 11/262,977

(22) Filed: Nov. 1, 2005

Related U.S. Application Data
(60) Provisional application No. 60/625,103, filed on Nov. 5, 2004.

(51) Int. Cl. G06F 17/30

(52) U.S. Cl. 707/3

(57) ABSTRACT

A professional matching service assists users to find a professional within a certain area of practice (AOP) and a specified geographic area. The service works with a database of professionals who subscribe to the service by selecting AOPs in which they want to be included. From a web page presenting organized links for the AOPs, a user clicks on an AOP link, which takes the user to a form to be completed with appropriate information for that AOP and the user's contact information. The user then initiates a search and is presented with a listing of subscribers near a zip code specified by the user and matching the AOP. The user can select subscribers to which the inquiry will be sent directly by email. The inquiry includes the user's contact information and inquiry details, allowing subscribers to decide whether to reply to the inquiry.

### CROSS-REFERENCE TO RELATED APPLICATION

The present patent application is based on, and claims priority from, U.S. provisional Application No. 60/625,103, filed Nov. 5, 2004, which is incorporated herein by reference in its entirety.

### COPYRIGHTED MATERIAL

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a matching service system and method for assisting users to find a professional, such as a law firm, within a certain area of practice and within their specified geographic area. More specifically, the invention relates to such a professional matching service that works with a database of professionals and is initiated through a link on a web site.

2. Related Art

Numerous online services exist for matching users with professionals, such as law firms. Examples of such online services for law firms and legal services include anattorneyforyou.com, legalmatch.com (for which there is a corresponding Published U.S. Appl. No. 2002/0038233), casepost.com, and lawyermatch.com, as well as Legal Services By Request, offered by Martindale-Hubbell through its lawyers.com web site, and casematch.com (for which there is a corresponding U.S. Pat. No. 6,470,338).

The services offered by anattorneyforyou.com, legalmatch.com, casepost.com, and lawyermatch.com, and Legal Services By Request all work with a lawyer database; and the front pages of anattorneyforyou.com, legalmatch.com, and casepost.com present organized links for areas of practice (AOPs). Further, anattorneyforyou.com, legalmatch.com, and casepost.com all allow the user to click on one of the AOP links, and all present the user with a form requesting information for the AOP (for example, the user's legal question) and the user's email address and postal code (which in the U.S., is the zip code).

With the services offered by anattorneyforyou.com, legalmatch.com, casepost.com, Legal Services By Request, and casematch.com, users of the service do not have a choice of attorneys. Inquiries are sent blindly to participating firms.

Many services, including lawyermatch.com, offer only sponsored links to professionals, with no attempt to match the user with professionals based on the specific needs of the user.

With many services, including Legal Services By Request, attorneys are not informed of prospective clients directly, but must access them via a portal requiring the attorney to login with username and password; no contact information is sent; and leads are anonymous, making it difficult for the attorney to decide whether to follow up with prospective clients.

With the services offered by legalmatch.com, attorneys matching the specific practice area and geographic location selected by the user are sent instant e-mail notifications. However, because the user does not have a choice of attorneys in the emailing of inquiries, the user may receive unwanted responses.

With the services offered by casematch.com, matching attorneys are sent email notifications with a case ID number and limited user information (for example, contact information is excluded). In order to evaluate the case, the attorney must login to the casematch.com web site with username, password, and the case ID number. Only then does the attorney receive full case information, including user contact information. The attorney can then contact the user. As noted above with respect to legalmatch.com, the user cannot pre-screen the attorneys from whom he or she receives responses.

While not directed to finding a legal professional, the method described by Freedman in Published U.S. Appl. No. 2003/0097291 permits the sponsor of a clinical trial to search for monitors based on various parameters, including region and therapeutic specialty, and then sorts monitors by location and experience, the sponsor being allowed to view monitor profiles.

It is to the solution of these and other problems to which the present invention is directed.

### SUMMARY OF THE INVENTION

It is accordingly a primary object of the present invention to provide a professional matching service that encompasses a system and method for assisting users to find a professional, such as a law firm, within a certain area of practice and within their specified geographic area, in which users can select to which of the subscribing professionals their inquiry is submitted.

It is another object of the present invention to provide a professional matching service that assists users to find a professional within a certain area of practice and within their specified geographic area, in which inquiries are sent directly to a subscribing professional's email box.

It is another object of the present invention to provide a professional matching service that assists users to find a professional within a certain area of practice and within their specified geographic area, in which subscribing professionals are provided with complete contact information for users whose inquiries they receive.

These and other objects of the present invention are achieved by a professional matching service that assists users to find a professional, such as a law firm, within a certain area of practice and within their specified geographic area. The professional matching service works with a database of professionals and is initiated through a link on a web site. Professionals can subscribe to the professional matching service by selecting areas of practice (AOPs) in which they will want to be included.

When a user wants to initiate the service, the user clicks the professional matching service link, which takes the user to a page describing the service and presenting organized links for all of the AOPs. The user clicks on one of the AOPs and is taken to a form, where the user fills out the appropriate information for that AOP, as well as his or her email address and zip code.

The user then initiates a search for subscribers to the service and is presented with a search results page displaying a listing of subscribers that are near the zip code and match the AOP entered by the user. Each listing has a checkbox through which the user can select or deselect the subscribers to which the user wants to send his or her inquiry.

Each listing has a link to a profile view that can be opened in a new browser window to allow the user to find out more about the subscriber. A map link is also available to show the user where the subscriber is geographically located so the user can make an informed decision about selecting a subscriber to contact. The user then submits his or her information to the selected subscribers, and receives a summary email with each of the selected subscribers' name and address.

The user's inquiry is sent directly to the email box of the selected subscribers. The inquiry includes the user's contact information and inquiry details, allowing the subscriber to decide whether to reply to the inquiry.

Other objects, features, and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a flowchart illustrating the high-level organizational process and workflows implemented by the professional matching service in accordance with the present invention.

FIG. 2 is an exemplary entry screen for the professional matching service in accordance with the present invention.

FIGS. 3A and 3B are alternative embodiments of an exemplary information input form for the professional matching service in accordance with the present invention.

FIG. 4 illustrates a zip code lookup functionality for the information input form for the exemplary information input form of FIG. 3.

FIG. 5 illustrates an interface allowing the user to select one of a plurality of zip codes in the exemplary information input form of FIG. 3.

FIGS. 6A and 6B are alternative embodiments of an exemplary search results page for the professional matching service in accordance with the present invention.

FIG. 7A is a generic, exemplary attorney profile page displayed to a user in the professional matching service in accordance with the present invention.

FIG. 7B is a specific, exemplary attorney profile page displayed to a user in the professional matching service in accordance with the present invention.

FIG. 8 is an exemplary confirmation screen presented to a user after submission of the user's request to the professional matching service in accordance with the present invention.

FIG. 9 shows an exemplary email inbox of a user with a summary email of the user's inquiry delivered thereto.

FIG. 10 shows an exemplary email inbox of a selected subscriber with a user inquiry delivered thereto.

FIG. 11 is an information input form for a new law firm subscription for the professional matching service in accordance with the present invention.

FIG. 12 an information input form by which up to three areas of practice can be input to be associated with the subscriber's subscription.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The present invention is a professional matching service that includes a system and method for assisting users to find a professional, such as a law firm, within a certain area of practice and within their specified geographic area specified by the user, the professionals being subscribers to the professional matching service and listed in a database associated with the professional matching service. The service is accessed through a web site having a search functionality, using computers connected to a server through a network.

For exemplary purposes only, the professional matching service is described in connection with legal services, wherein the professional matching service is an attorney matching service that helps users find a law firm within a certain area of practice and within their specified geographic area. It will be understood by those skilled in the art that the professional matching service can be used to locate members of other professions and trades, including, but not limited doctors, dentists, architects, tutors, and building contractors.

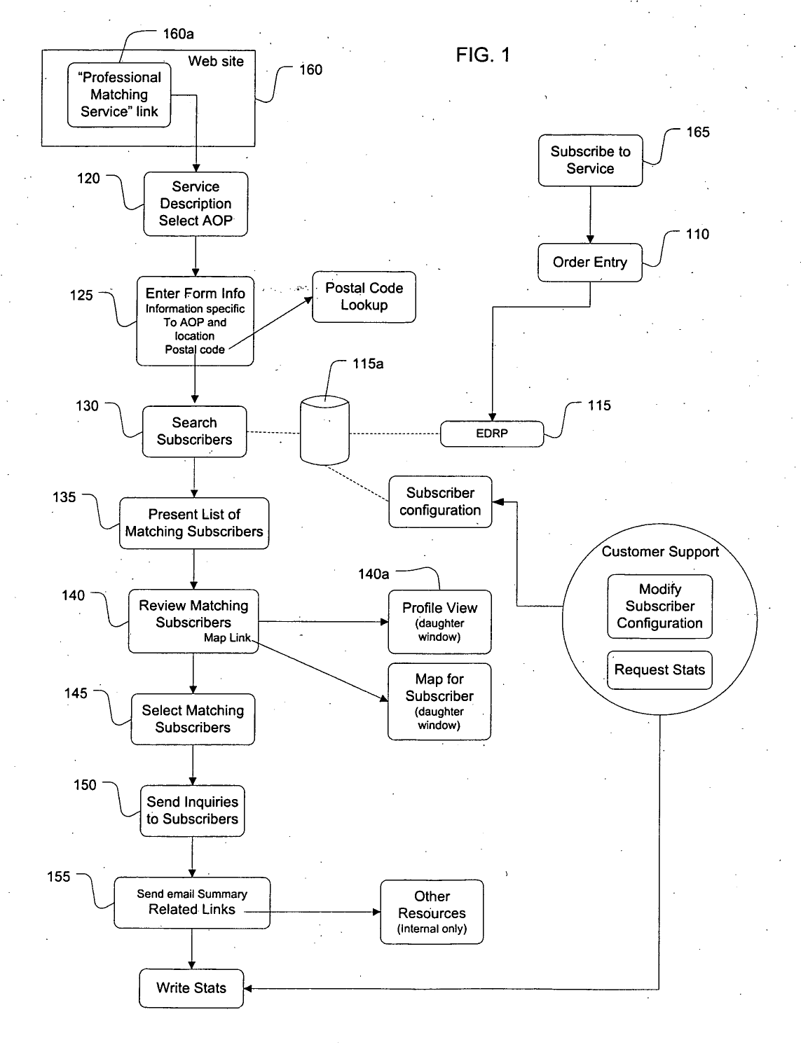

FIG. 1 is a flowchart illustrating the high-level organizational process and workflows implemented by the professional matching service. In accordance with the present invention, the professional matching service comprises a computer-implemented method for matching users seeking the services of a professional within a certain area of practice and within a specified geographic area with professionals matching those criteria. The method including the steps of: (i) inputting subscriber information including at least the subscriber name, address, AOPs subscribed, and contact information and a subscriber profile that includes at least the subscriber's address and description of the subscriber's business, but excluding the subscriber's contact information (step 110); (ii) securely storing the subscriber information in a database 115a (step 115); (iii) inputting information from users, including at least the AOP for which the user requires assistance (step 120), and information appropriate to the AOP and the user's inquiry (step 125), including email address and zip code (steps 125 and 125a); (iv) initiating a search for subscribers near the zip code specified by the user and matching the user's selected AOP (step 130); (v) presenting a list of matching subscribers to the user (step 135); (vii) viewing the stored profiles of the matching subscribers (step 140); (viii) selecting the matching subscribers to which the user's inquiry will be submitted (step 145); (ix) automatically generating emails to the selected subscribers, providing information regarding the user's inquiry and contact information (step 150); and (x) automatically generating a summary email confirmation to the user, providing information regarding the user's inquiry (step 155).

Further in accordance with the purpose of the invention, the invention comprises a system for matching users seeking the services of a professional within a certain area of practice and within a specified geographic area with professionals matching those criteria. The system includes: a memory configured to store instructions; and a processor configured to execute instructions for: (i) enabling the input of subscriber information including at least the subscriber name, address, AOPs subscribed, and contact information and a subscriber profile that includes at least the subscriber's address and description of the subscriber's business, but excludes the subscriber's contact information; (ii) securely storing the subscriber information in a database; (iii) enabling users to input information, including at least the AOP for which the user requires assistance, information appropriate to the AOP and the user's inquiry, email address, and zip code; (iv) searching for subscribers near the zip code specified by the user and matching the user's selected AOP; (v) presenting a list of matching subscribers to the user; (vii) enabling the user to view the stored profiles of the matching subscribers; (viii) enabling the user to select the matching subscribers to which the user's inquiry will be submitted; (ix) automatically generating emails to the selected subscribers, providing information regarding the user's inquiry and contact information and (x) automatically generating a summary email confirmation to the user, providing information regarding the user's inquiry.

In the case of legal services, the service can be implemented through a web site 160 that provides profiles of attorneys and firms and their areas of practice (“AOPs”) through a database associated with the web site. An example of such a web site is the lawyers.com web site, which provides profiles of attorneys and firms worldwide, as well as web sites for law firms featuring details such as AOPs, professional credentials, fees, office hours and directions.

Exemplary AOPs for the legal profession are listed in the APPENDIX. The AOPs for the attorney matching service match as closely as possible the taxonomy of AOPs on the web site. Matching the AOPS between the attorney matching service and the web site provides a better user experience because there is a familiar look and function in the selection of a practice area.

The professional matching service works with the web site database and is initiated through an “Attorney Matching” link 160a, which appears at least on the web site home page. Lawyers and law firms can subscribe to the attorney matching service by selecting the areas of practice (AOPs) in which they want to be included (step 165), as will be described in greater detail hereinafter.

The inquiry process starts with a user wanting to have lawyers and/or law firms respond to his or her situation. Most often, the user will be seeking a local lawyer or law firm, although this need not be the case.

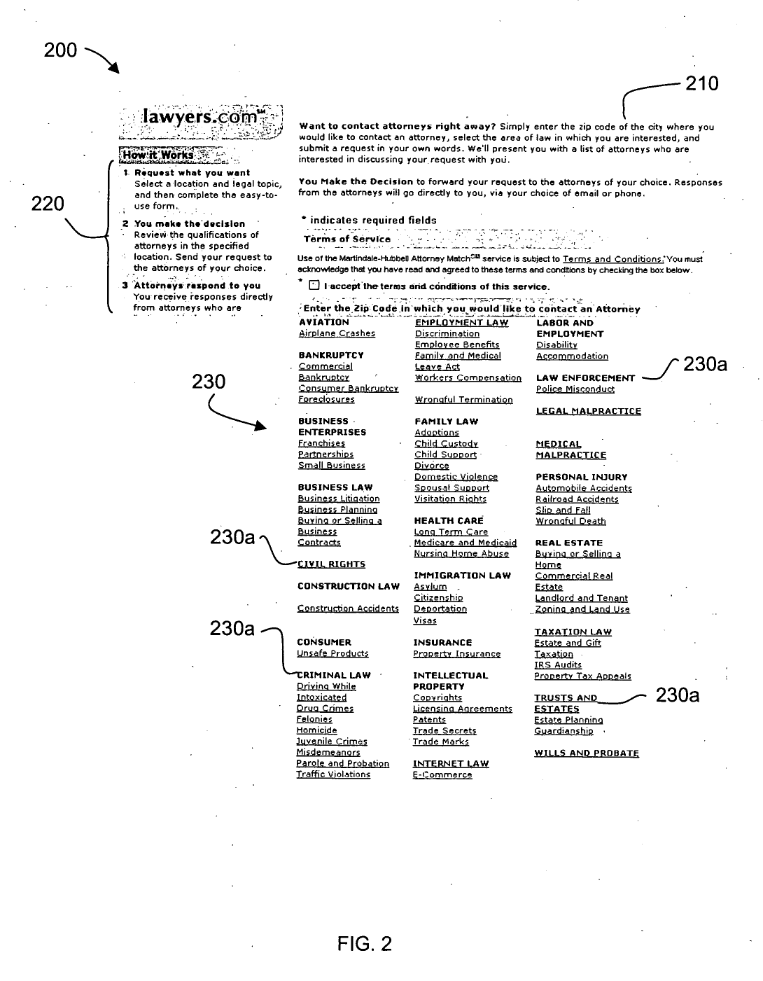

When a user wants to initiate the attorney matching service, he or she clicks the “Attorney Matching” link (FIG. 1, step 160a), which takes the user to an entry screen 200 (shown in FIG. 2) for the attorney matching service. The entry screen is the first screen that is presented to a user after the user clicks on the “Attorney Matching” service link on the web site. This screen presents a description of the service 210 and the steps 220 that are necessary to send the inquiry to the selected law firms. This screen also presents organized links 230 for all of the AOPs.

The areas of practice are presented in a format that has a high level of usability to the user. Thus, areas of practice are associated with a category 230a whenever possible and preferably are presented to the user on a page rather than in a long dropdown list.

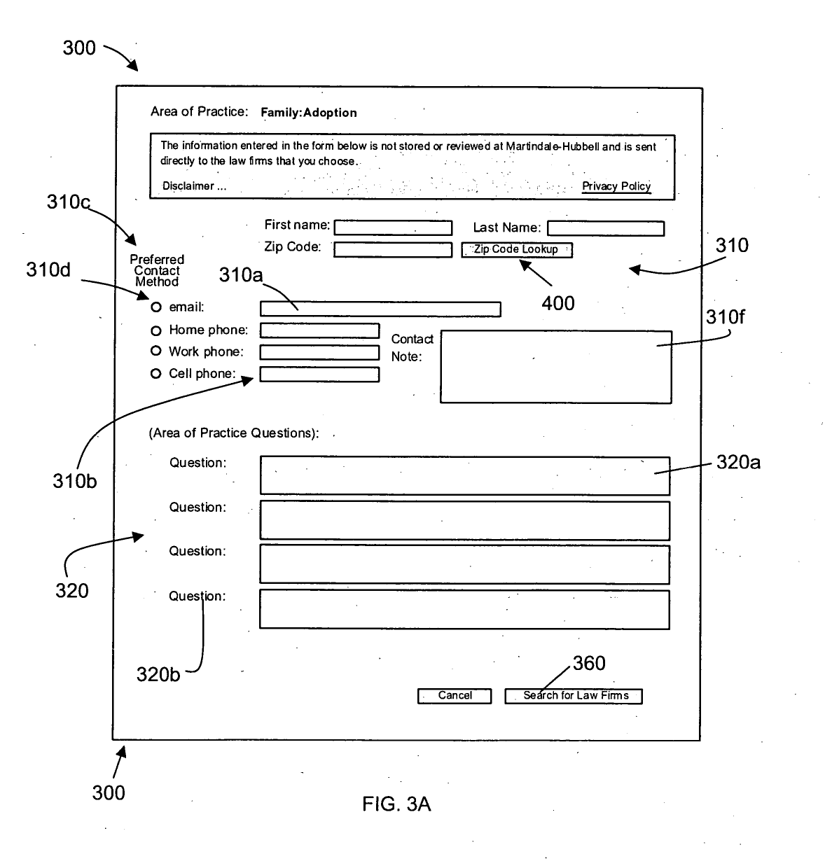

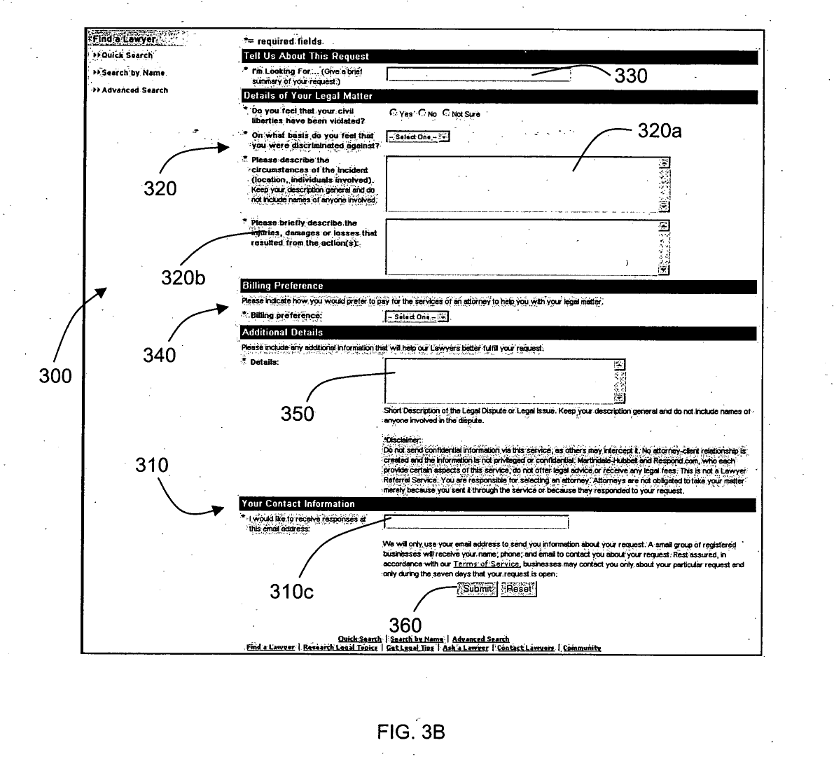

The AOPs allow a user to select an area for his or her legal situation and serve to channel the user to the appropriate input form before a search is initiated. The user clicks on one of the AOPs and is taken to a form 300 (shown in FIG. 3A for the “Family: Adoption” AOP), in which the user enters his or her contact information 310 (including email address 310a), location (which as shown in FIG. 3A, can be limited to a zip code, but can also include street address, city, and state), the appropriate information 320 for the selected AOP, and information about his or her legal situation for which he or she would like to get assistance. As shown in FIG. 3A, in addition to an email address 310a, the user can designate telephone contact information 310b (including home, work, and cell telephone numbers), and also can indicate the preferred contact method 310c, for example by selecting a radio button 310d, as shown in FIG. 3A, or by entering information in a box 310e, as shown in FIG. 3B. A box 310f is also provided for the user to provide a note relating to the contact information.

The information input form preferably captures the email address 310a for the user through two email address inputs. If the addresses do not match, an error is generated that will inform the user that the email inputs do not match and must be entered again.

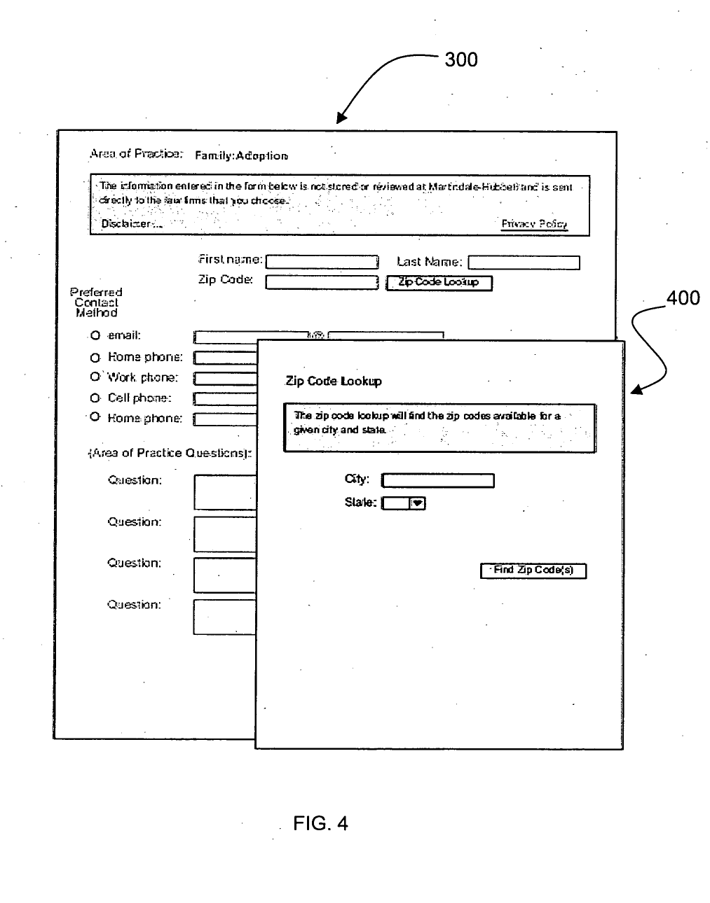

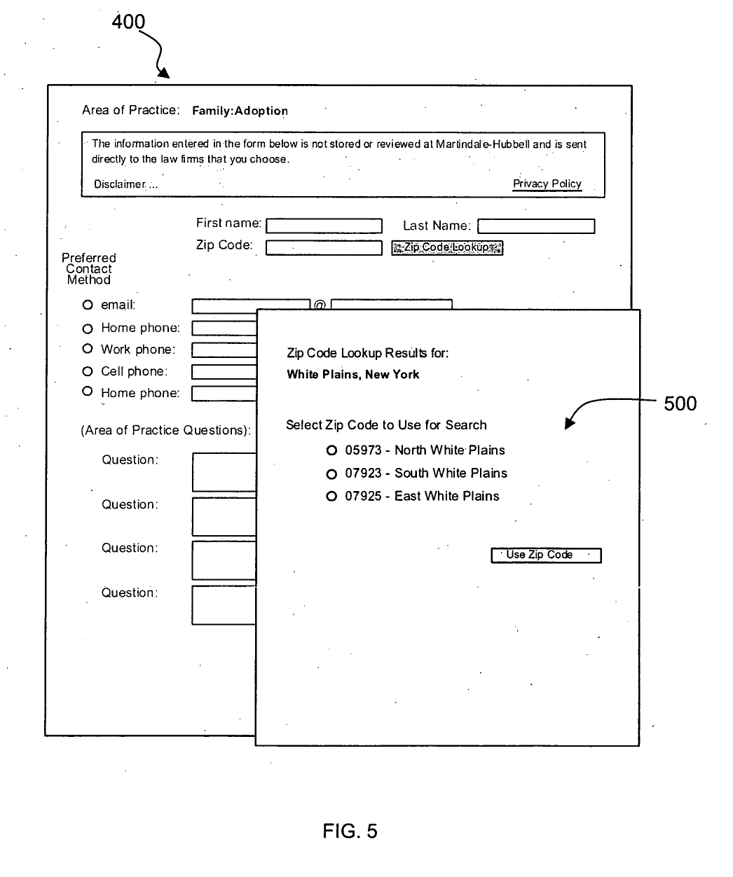

As shown in FIG. 4, a zip code lookup functionality 400 on the input form provides the user a way of finding the zip code for a particular city/state combination. If there is more than one zip code for the city entered by the user, an interface 500 (shown in FIG. 5) allows the user to select a zip code to use in the form.

The input form 300 also provides space for the user to enter answers 320a specific to the AOP. The input form 300 shown in FIG. 3A includes four questions 320b, but as will be appreciated by those of skill in the art, the type and number of questions and corresponding answer spaces can be varied according to the profession or trade and the AOP, as shown in FIG. 3B. For example, as shown in FIG. 3B (for the “Civil Rights” AOP), the input form 300 can also include a space 330 for the user to input a summary of his or her request, a menu 340 for selecting billing preference, and a space 350 for inputting additional information not otherwise provided for.

After the user has input all the required information, the user initiates a search for subscribers to the attorney matching service by clicking on a “Search” or “Submit” button 360 provided in the information input form. A search engine searches for subscribers to the attorney matching service (FIG. 1, step 130). The search is enabled using the web site database by tagging the subscribed law firms with the attorney matching service.

The search is based on geospacial data (that is, it is based on proximity), and more specifically, on the zip code captured from the information entered by the user on the input form. The search range starts at the zip code and continues out to the state borders until the first ten subscribers are found that list the AOP selected by the user. The search is confined to the state in which the search was initiated, based on the zip code that was entered in the input form.

A distance calculation is performed from the zip code entered by the user to each of the subscribers' addresses. In order to compute the distance to the subscribers, the zip code has an associated city to which it refers, as well as coordinate information. The search engine also can sort subscribers based on proximity and present the list of matching subscribers by nearest to farthest distance.

The search uses only the first 5 digits of zip code and does not capture the extended 4 digits of zip code, because the extended 4 digits of the zip code are used for routing and identification of which side of the street the address is located.

The web site database is geocoded to enable the geospacial search functionality. Methods for geocoding are well known in the art. The data formats for the location information must be compatible with the specific geospacial coding done for the search engine. Re-geocoding the database for any updated addresses is performed at a regular interval.

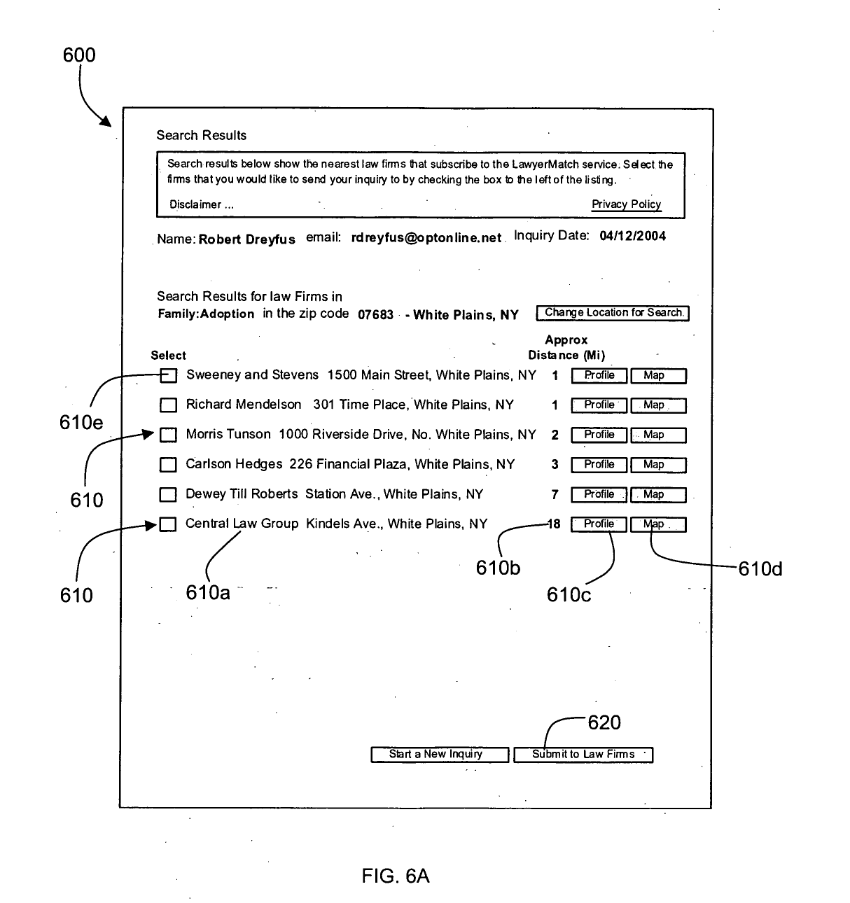

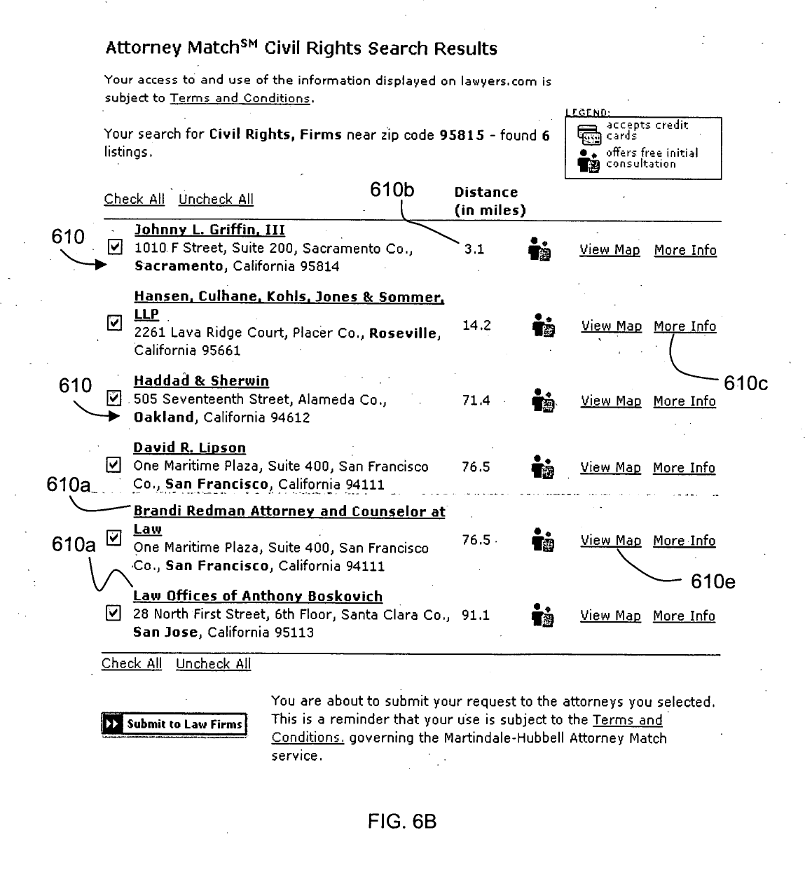

On a search results page 600 (shown in FIGS. 6A and 6B), the search engine returns listings 610 of the law firms 610a that are subscribed to the AOP (entered in the form). The listings 610 preferably include a display of the approximate distance 610b from the user to each of the subscribers (law firms), based on the user's zip code. This distance is labeled as “Approx” and is preferably rounded to the nearest mile.

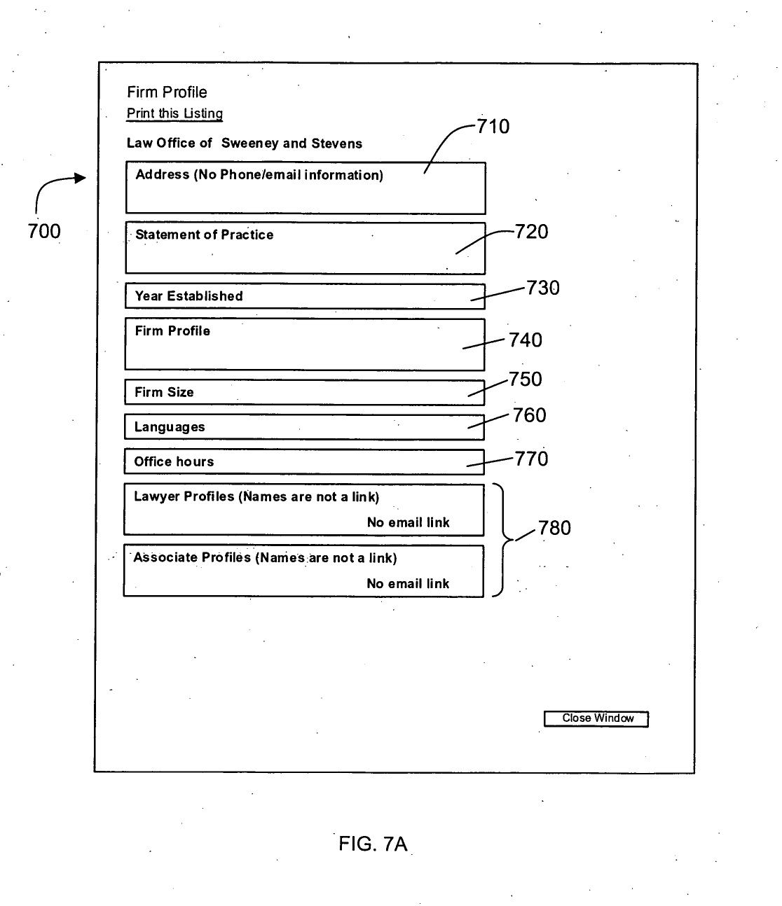

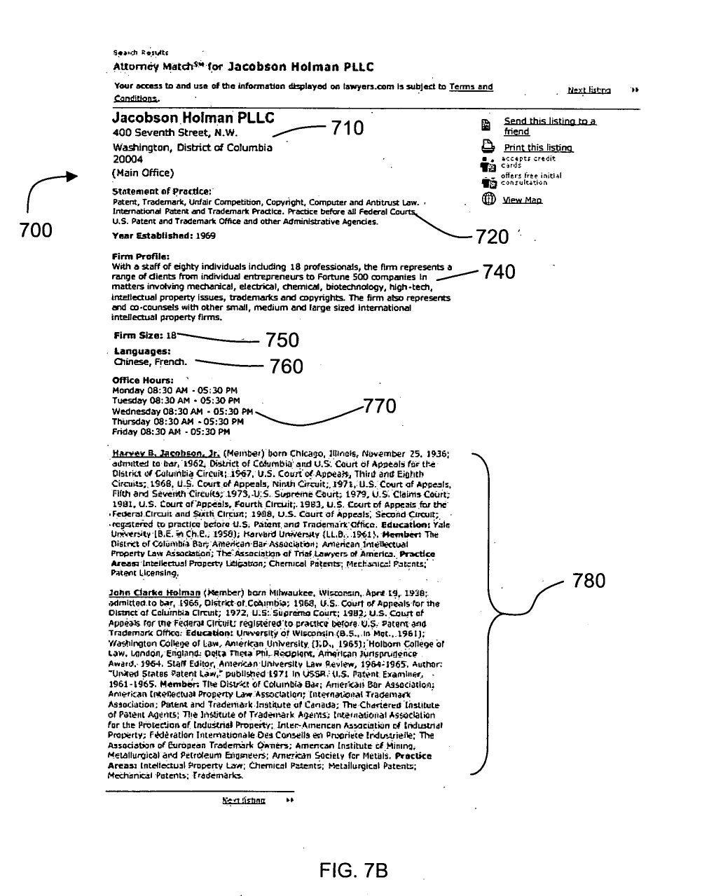

The listing 610 does not include a link to the subscribers' own business web sites. Instead, a link 610c is presented for each subscriber on the search results page that will open a new window 700 (shown in FIGS. 7A and 7B) with the subscriber's profile information (FIG. 1, step 140a). The information presented does not include any contact information such as phone number, email address, or web site link, but can include information such as address 710, a practice description 720, the year established or number of years in practice 730, a brief firm profile 740, the firm size 750, languages spoken 760, office hours 770, and attorney profiles 780.

A link 610e to a map and directions (for example, provided by a mapping web site such as MapQuest.com) is also provided with each subscriber's listing to show where the subscriber is located, to help a user decide whether he or she would like to submit information to the subscriber.

The subscribers are listed by proximity to the user's zip code, with the nearest subscriber presented at the top of the list and the farthest away presented at the bottom of the list. The nearest ten subscribers are presented that are located within the state where the search was initiated. If more than ten subscribers match to the same rounded mileage, all matches are displayed.

The number of subscribers presented in the search results must be high enough to make it reasonably likely that the user will get responses. Ten subscribers is believed to be the minimum number for this purpose, although the number can be increased or decreased.

The search engine checks to ensure there are at least two firms near the zip code entered by the user and with the AOP selected by the user; otherwise the attorney matching service returns a message suggesting that the user select a different AOP. Alternatively, the attorney matching service can include functionality to send a link to a quick search on the web site if the search returns fewer than two subscribers. The quick search can be prefilled to the AOP so that it is ready to search. This functionality is only possible as long as the attorney matching service and the web site are using the same AOPs.

Each listing 610 on the search results includes a means, for example, a check box 610e next to each subscriber listing, that allows the user to select which subscribers should receive the inquiry information. When the user clicks on a “Submit” button 620, the information gathered in the information input form 300 is sent to the subscribers selected by the user. Once the information is sent to the subscribers, it is up to them to manage this inquiry information and follow up with the user.

A filter can be implemented that checks the input form for profanity before it is delivered to the law firm. The filter does not let forms that contain profanity be sent to the law firms but instead sends the entire message with contact information to an area that is addressed by customer support for the attorney matching service.

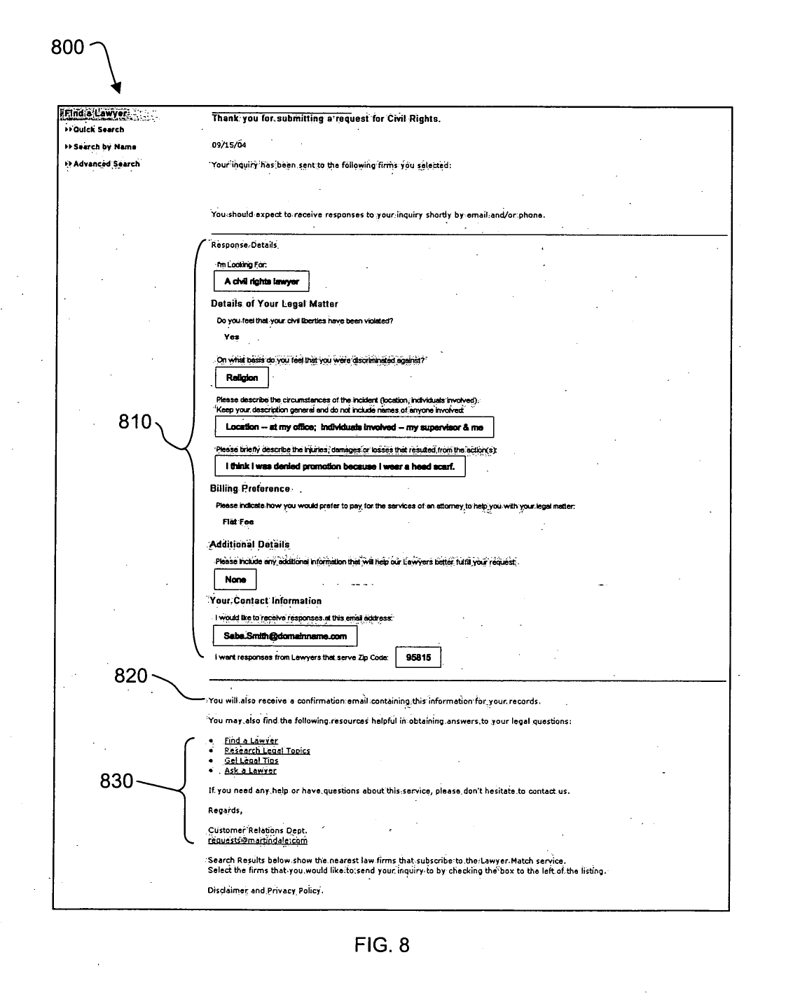

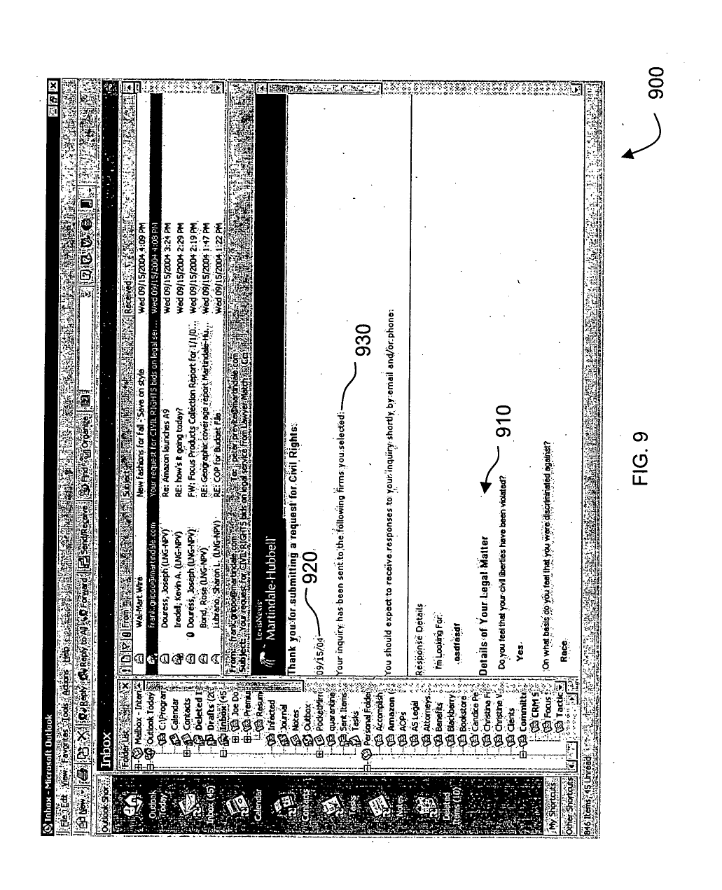

When the user submits an inquiry, a confirmation screen 800 (shown in FIG. 8) is presented to the user that describes what is being submitted and to whom (a recapitulation 810 of the information entered in the information input form and the list of selected subscribers), and includes both a message 820 that a summary email is being sent along with resource links 830. The email summary 900 (FIG. 9) is sent to the user at the time the information is submitted to the subscribers 910, and reiterates the information presented in the confirmation screen. The summary lists the date submitted 920, the subscribers who received the information 930 along with guidelines, the subscriber's name and address, disclaimers, and resource links to the AOP the user selected. The confirmation screen 800 and email summary 900 do not include the selected subscribers' contact information (telephone number and email address) because preferably, the contact is to be initiated by the subscribers. However, it is possible to include the subscribers' contact information in the confirmation screen and email summary, to permit the user to follow up with the selected subscribers, if necessary.

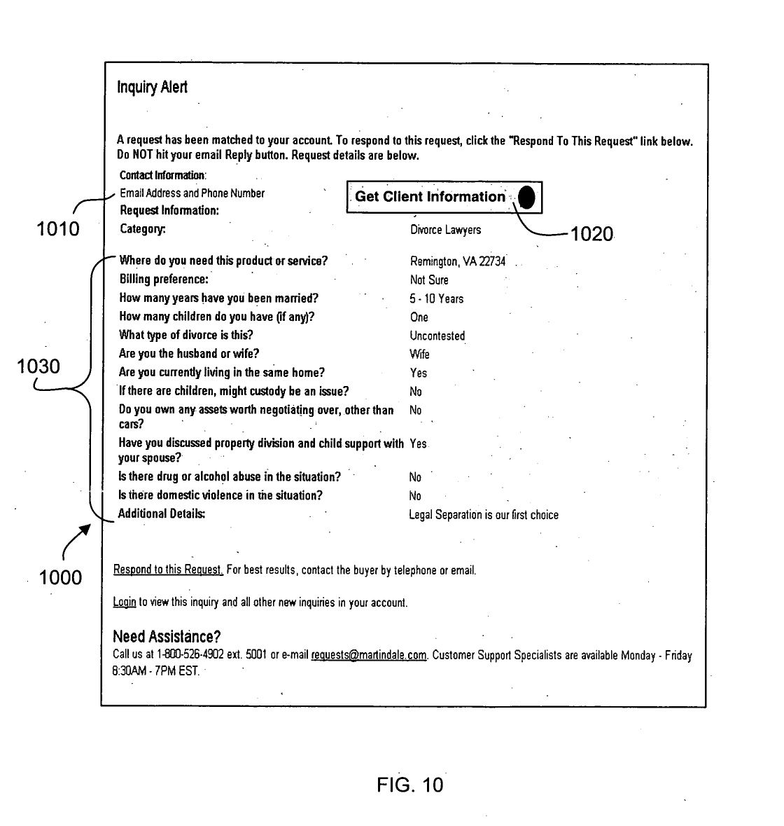

As shown in FIG. 10, the user inquiry is delivered as an email 1000 directly to the email inbox of the selected subscribers, eliminating the need for subscribers to login to a separate interface. The email to the selected subscribers includes the user's basic contact information 1010 (including name and preferred method of contact (email, home phone, work phone, etc.)) and/or a link 1020 for retrieving more detailed information for the user. Each area of practice has specific information 1030 that is appropriate and allows a subscriber to quickly make an evaluation whether he or she would be interested in taking the user's case. The subscriber can then reply to the user via email or phone (whichever the user has identified as his or her preference). In addition, the subscriber can save all email inquiries to retain for his or her records

A subscriber must have one matching address for each Area of Practice (AOP) to which it subscribes. Each email address that corresponds to the AOPs may either be different or the same. The attorney matching service permits a subscriber to:

add or delete an AOP.

change the associated email address for each AOP subscribed.

retain at least one AOP and email address if others are deleted.

use the same email address for all subscribed AOPs.

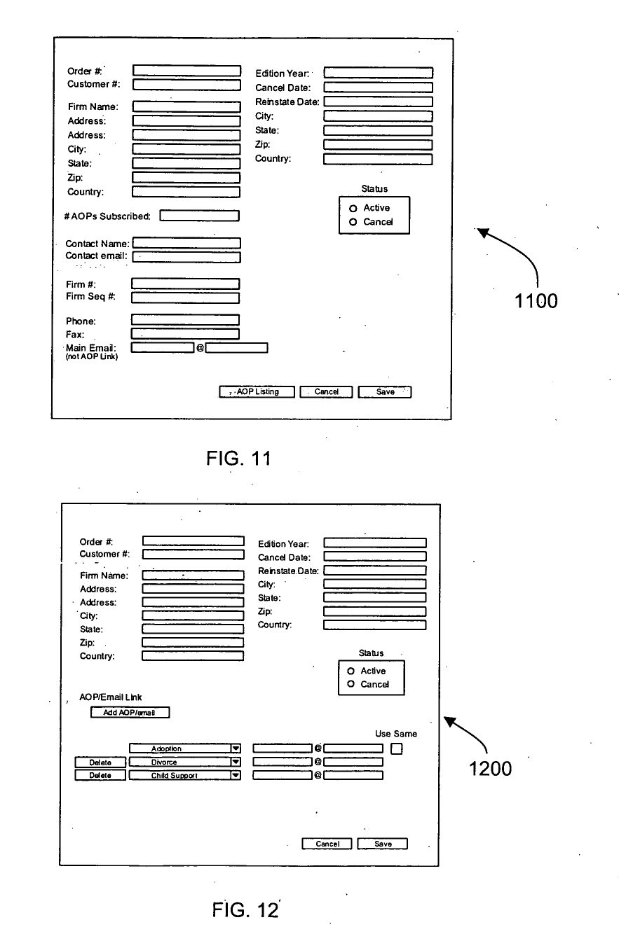

Subscriptions to the attorney matching service are based on subscribers' zip codes. A lawyer or law firm that is signing up for the attorney matching service must have a listing in the database and also have an office within the zip code for which the subscription is requested. Firms that are requesting an attorney matching service subscription for a particular zip code cannot use a cross-reference to a different zip code. FIG. 11 shows an information input form 1100 for a new law firm subscription.

Each of a firm's office locations (zip code) is an additional Attorney matching service account. A firm may have multiple attorney matching service accounts, with each account associated with the zip code in which the office is located. Each Attorney matching service account may have multiple associated areas of practice.

The attorney matching service can establish a pricing system under which there is a base charge for a base, or standard, number of AOPs to which subscribers subscribe. If the base number of AOPs is three, for example, an AOP may be deleted so that a subscriber has only one or two AOPs, but the subscriber will still be billed at the standard rate of three AOPs. The subscriber can subscribe to additional AOPs for an additional charge. A subscriber has to have at least one AOP at all times. As will be appreciated by those of skill in the art, as a practical matter, aside from pricing considerations, the number of AOPs to which a subscriber can subscribe is limited only by the number of AOPs for the attorney matching service. FIG. 12 shows an information input form 1200 by which a subscriber can input up to three AOPs to be associated with the subscriber's subscription.

The only error checking that is implemented is a bounce report in stats. The bounce report will take into account that there is an issue in sending email to a subscriber. These issues are addressed by someone in customer support. There is no attempt to check email bouncing for the summary that is sent to the user.

The attorney matching service captures statistics that are supplied to subscribers on an as requested basis. The statistics are generated each time an input form is filled out and a search is initiated by the submission of form information to subscribers.

The attorney matching service generates AOP usage statistics at the time the information is emailed to the subscribers. Captured information includes how many leads a subscriber gets by AOP on a monthly basis. A software solution such as WebSideStory's Hitbox (which uses real-time web site analysis to show where site visitors come from, what content and products they look at, and which navigational paths they take through a web site) can be used to capture usage statistics.

The attorney matching service can include a “Check email” option for subscribers, which enables subscribers to see if their emails have been opened. A check to see if email is opened at the subscriber level adds more service information to the stats reports.

It is to be understood that the present invention is not limited to the illustrated user interfaces or to the order of the user interfaces described herein. Various types and styles of user interfaces may be used in accordance with the present invention without limitation.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A computer-implemented method for matching users seeking the services of a professional within a certain area of practice and within a specified geographic area with professionals matching those criteria, comprising the steps of:
(i) inputting subscriber information including at least the subscriber name, address, areas of practice subscribed, and contact information and a subscriber profile including at least the subscriber's address and description of the subscriber's business, but excluding the subscriber's contact information;
(ii) securely storing the subscriber information in a database;
(iii) inputting user information from users, including at least the area of practice for which the user requires assistance, the geographic area in which the user requires assistance, the user's email address, and information appropriate to the area of practice and the user's inquiry;
(iv) initiating a search for subscribers near the geographic area specified by the user and matching the user's selected area of practice;
(v) presenting a list of matching subscribers to the user;
(vii) presenting the stored profile of any of the matching subscribers requested by the user;
(viii) selecting the matching subscribers to which the user's inquiry will be submitted;
(ix) automatically generating emails to the selected subscribers, providing information regarding the user's inquiry and contact information; and
(x) automatically generating a summary email confirmation to the user, providing information regarding the user's inquiry.

2. The method of claim 1, wherein in step (iii), the user information is input into an input form including questions specific to the area of practice and spaces for the user to enter answers to the questions.

3. The method of claim 1, wherein in steps (iii) and (iv), the geographic area is designated by a zip code.

4. The method of claim 3, wherein in step (iv), the search starts at the zip code and continues out to borders of the state in which the zip code is located until the first ten subscribers are found matching the area of practice selected by the user.

5. A system for matching users seeking the services of a professional within a certain area of practice and within a specified geographic area with professionals matching those criteria, comprising:
memory means for storing instructions; and
processor means for executing instructions for:
(i) enabling the input of subscriber information including at least the subscriber name, address, areas of practice subscribed, and contact information and a subscriber profile including at least the subscriber's address and description of the subscriber's business but excluding the subscriber's contact information;
(ii) securely storing the subscriber information in a database;
(iii) enabling users to input user information, including at least the area of practice for which the user requires assistance, the geographic area in which the user requires assistance, the user's email address, and information appropriate to the area of practice and the user's inquiry;
(iv) searching for subscribers near the geographic area specified by the user and matching the user's selected area of practice;
(v) presenting a list of matching subscribers to the user;
(vii) enabling the user to view the stored profiles of the matching subscribers;
(viii) enabling the user to select the matching subscribers to which the user's inquiry will be submitted;
(ix) automatically generating emails to the selected subscribers, providing information regarding the user's inquiry and contact information and
(x) automatically generating a summary email confirmation to the user, providing information regarding the user's inquiry.

6. The system of claim 5, wherein the instructions executed by the processor means enables the user information to be input into an input form including questions specific to the area of practice and spaces for the user to enter answers to the questions.

7. The system of claim 5, wherein the geographic area is designated by a zip code.

8. The system of claim 7, wherein the instructions executed by the processor means start searching at the zip code and continues out to borders of the state in which the zip code is located until the first ten subscribers are found matching the area of practice selected by the user.

9. A computer program product for matching users seeking the services of a professional within a certain area of practice and within a specified geographic area with professionals matching those criteria, the computer program product comprising a computer usable storage medium having computer readable program code means embodied in the medium, the computer readable program code means comprising:
(i) enabling the input of subscriber information including at least the subscriber name, address, areas of practice subscribed, and contact information and a subscriber profile including at least the subscriber's address and description of the subscriber's business but excluding the subscriber's contact information;
(ii) securely storing the subscriber information in a database;
(iii) enabling users to input user information, including at least the area of practice for which the user requires assistance, the geographic area in which the user requires assistance, the user's email address, and information appropriate to the area of practice and the user's inquiry;
(iv) searching for subscribers near the geographic area specified by the user and matching the user's selected area of practice;
(v) presenting a list of matching subscribers to the user;
(vii) enabling the user to view the stored profiles of the matching subscribers;
(viii) enabling the user to select the matching subscribers to which the user's inquiry will be submitted;
(ix) automatically generating emails to the selected subscribers, providing information regarding the user's inquiry and contact information and
(x) automatically generating a summary email confirmation to the user, providing information regarding the user's inquiry.

10. The computer program product of claim 9, wherein the instructions executed by the computer readable program code means for executing instructions enables the user information to be input into an input form including questions specific to the area of practice and spaces for the user to enter answers to the questions.

11. The computer program product of claim 9, wherein the geographic area is designated by a zip code.

12. The computer program product of claim 11, wherein the instructions executed by the computer readable program code means for executing instructions start searching at the zip code and continues out to borders of the state in which the zip code is located until the first ten subscribers are found matching the area of practice selected by the user.
